(19) United States
(12) Patent Application Publication
(10) Pub. No.: US 2017/0213118 A1
(43) Pub. Date: Jul. 27, 2017

(54) STICKER, CONDITION MONITORING SYSTEM, METHOD & COMPUTER PROGRAM PRODUCT

(71) Applicant: Aktiebolaget SKF, Goteborg (SE)

(72) Inventors: Anders Welin, Torslanda (SE); Svetoslav Staykov, Varna (BG)

(21) Appl. No.: 15/406,992

(22) Filed: Jan. 16, 2017

(30) Foreign Application Priority Data
Jan. 22, 2016 (SE) 1650074-6

(51) Int. Cl. G06K 19/06

(52) U.S. Cl. CPC G06K 19/06037; G06K 19/06028

(57) ABSTRACT

A sticker for attaching to at least one part of a machine having at least one rotating component that is to be monitored. The sticker provides a machine-readable label, such as a Quick Response (QR) code or bar code, which contains information about the component, such as a serial number of the component, and a processor arranged to collect information concerning the use of the at least one rotating component and/or the machine and a transmitter that is arranged to automatically transmit the collected information if/when the processor collects information that a temperature of the at least one part of the machine having at least one rotating component being monitored exceeds a predetermined temperature or a vibration of the at least one part of the machine being monitored exceeds a predetermined level. The transmitted collected information is arranged to be associated with the machine-readable label.

### CROSS REFERENCE TO RELATED APPLICATIONS

This application claims priority to Swedish patent application no. 1650074-6 filed on Jan. 22, 2016, the contents of which are fully incorporated herein by reference.

### FIELD OF THE INVENTION

The present invention concerns a sticker for attaching to at least one part of a machine comprising at least one rotating component that is to be monitored and a condition monitoring system for monitoring at least one machine comprising at least one rotating component, which provides at least one such sticker and a receiver arranged to receive information transmitted from the at least one sticker. The present invention also concerns a method and computer program product for monitoring the condition of at least one machine comprising at least one rotating component.

### BACKGROUND OF THE INVENTION

Condition monitoring is the process of determining the condition of machines comprising at least one rotating component while the machines are in operation. Condition monitoring enables the repair of problem rotating components prior to their failure and not only helps plant personnel reduce the possibility of catastrophic failure, but also allows them to order parts in advance, schedule manpower, and plan other repairs during downtime.

Rotating components such as bearings or gears are often used in critical applications, wherein their failure in service would result in significant commercial loss to the end-user. It is therefore important to monitor such rotating components in order to plan intervention in a way that avoids failure in service, while minimizing the losses that may arise from taking the machinery in question out of service to replace a bearing or gear.

The residual life of a rolling-element bearing is generally determined by fatigue of the operating surfaces as a result of repeated stresses in operational use. Fatigue failure of a rolling element bearing results from progressive flaking or pitting of the surfaces of the rolling elements and of the surfaces of the corresponding bearing races. The flaking and pitting may cause seizure of one or more of the rolling elements, which in turn may generate excessive heat, pressure and friction.

Bearings are selected for a specific application on the basis of a calculated or predicted residual life expectancy compatible with the expected type of service in the application in which they will be used. However, this type of life prediction is considered inadequate for the purpose of maintenance planning for several reasons.

One reason is that the actual operation conditions may be quite different from the nominal conditions. Another reason is that a bearing's residual life may be radically compromised by short-duration events or unplanned events, such as overloads, lubrication failures, installation errors, etc. Yet another reason is that, even if nominal operating conditions are accurately reproduced in service, the inherently random character of the fatigue process may give rise to large statistical variations in the actual residual life of substantially identical bearings.

In order to improve maintenance planning, it is common practice to monitor the values of physical quantities related to vibrations and temperature to which a rotating component, such as a bearing, is subjected in operational use, so as to be able to detect the first signs of impending failure.

In a condition monitoring system data is usually obtained from at least one sensor provided in the vicinity of a rotating component that is to be monitored and this data is usually transmitted in a wired or wireless manner and displayed to an analyst. This can however result in long transmission and display times and the data can be difficult to display or interpret. The transmission, display, storage and interpretation of such data can require a significant amount of energy, time and expertise, and consequently decreases the rate at which measurements and analyses can be made.

### BRIEF SUMMARY OF THE INVENTION

An object of the invention is to provide an improved and simple way of monitoring at least one part of at least one machine comprising at least one rotating component.

This object is achieved by using a sticker for attaching to at least one part of a machine comprising at least one rotating component that is to be monitored, i.e. directly to a part of a machine, to the rotating component or its housing, or indirectly in the vicinity of the machine or a component part or its housing. The sticker provides a machine-readable label, such as a Quick Response (QR) code, bar code, or serial number, which contains information about the component, such as a serial number of the component and/or type of the component, such as bearing type and/or information from the component manufacturer. Once an operator has selected a particular machine type that he/she wants to monitor, for example by selecting a machine from a machine list which may be provided by a condition monitoring system that provides the sticker, and installed the rotating component, the machine-readable code will link the installed rotating component (i.e. information concerning the rotating component such as its serial number and/or type, such as bearing type and/or its position (i.e. drive end (DE) or non-drive end (NDE)) with the machine in which it has been installed. An operator may optionally retrieve information concerning a rotating component having a particular serial number from a database once such information has been obtained from the machine readable label.

The information contained in this machine-readable label may be associated with data collected from the sticker during the use of the machine, whereby the performance of that machine or that at least one component may be tracked and optionally recorded. Optionally the machine-readable label, if provided together with a machine or rotating component, may be used as a counterfeit check by a machine or component manufacturer and/or an end-user to check the authenticity of the machine or rotating component.

The sticker also provides a processor arranged to collect information concerning the use of the at least one component and/or machine. Additional information may be collected from sensors, such as SKF Insight® monitors, located in the sticker itself or in wired or wireless communication with the sticker, such as sensors located on, in or in the vicinity of the rotating component being monitored. When a rotating component of a machine comprising at least one rotating component is replaced, a new machine-readable label, which may be provided with the replacement component, may be placed over the previous machine-readable label of the existing sticker so that the existing sticker's processor and/or sensor(s) can be re-used. Performance data can then be calculated once the new machine-readable label has been linked to the machine and/or a specific part of the machine (i.e. drive end (DE) or non-drive end (NDE)).

The sticker also provides a transmitter that is arranged to automatically transmit the collected information if/when the processor collects information that a temperature value of the at least one part of the machine comprising at least one rotating component being monitored exceeds a predetermined temperature value or a vibration level of the at least one part of the machine comprising at least one rotating component being monitored exceeds a predetermined vibration level. The transmitted collected information is arranged to be associated with the machine-readable label, i.e. any receiver of such information will know that the information concerning excessive temperature or excessive vibration concerns a particular machine and/or component being monitored.

Such a sticker provides a quick, simple and cost-effective way of determining whether a machine comprising at least one rotating component is operating correctly and can immediately attract the attention of an operator if a machine or machine component is not operating correctly, i.e. as soon as the temperature or vibration of the machine comprising at least one rotating component is above or below a certain threshold. Using such a sticker avoids the need to transmit and/or display and/or store actual vibration or temperature data, which may thereby reduce the amount of data that needs to be transmitted, displayed and/or stored. Data processing times may be shorter and memory storage requirements may be lower.

Information may be collected by the processor and transmitted by the transmitter continuously, periodically, randomly, on request and/or at any suitable time. It is preferable that information is only transmitted by the transmitter when necessary, since traffic over the communication network(s) will thereby be kept to a minimum. Signal processing filters may be used to remove spurs or noise in order to output a stable mean value and provide information that is less effected by outside events.

A user and/or a component manufacturer can be warned of deterioration in the condition of a component being monitored. Excessive vibration or temperature may be caused by poor installation, poor operating practices, such as misalignment, imbalance, lubrication failure and contamination, excessive loads, excessive operating speed, fatigue failure, wear, corrosion and/or exposure to mechanical shocks etc. Such causes of excessive vibration or temperature may reduce the residual life of the machine comprising at least one rotating component if left uncorrected. The vibration and/or temperature status information collected by the sticker's processor may be used for determining when it is necessary or desirable to check, service or replace or refurbish a component being monitored. For example, during the commissioning of a system, a manufacturer or end user may select or adjust one or more alarm limits based on the temperature and vibration levels that may be expected during the use of the machine comprising at least one rotating component.

A user of a condition monitoring system may be offered a list of machine models containing one or more different types of machine, such as electric motors, pumps, gearboxes etc. A user may select a machine that is to be monitored from the list of machine models and link at least one rotating component of that machine to the machine using at least one sticker. The at least one sticker may then be used to collect vibration and/or temperature data.

The word “sticker” as used in this document is intended to mean a piece of material, such as paper, plastic or metal or any other suitable material or combination of materials. The sticker is arranged to be permanently or non-permanently attached to at least part of a machine comprising at least one rotating component that is to be monitored or in the vicinity thereof, by means of adhesion for example.

According to an embodiment of the invention the processor is arranged to calculate at least one of the following: average temperature, average vibration level, running time. Information, such as the running time, may be calculated when the vibration and/or temperature is above a pre-determined threshold. According to an embodiment of the invention the sticker is arranged to start calculating and/or transmitting such calculated values only on request for example when the sticker is tapped by a user a predetermined number of times or when the sticker receives a signal, such as a light or magnetic signal or any other suitable signal, instructing it to start calculating and/or transmitting the calculated values, whereby energy may be saved by only activating the processor when necessary.

According to an embodiment of the invention the sticker provides storage means arranged to at least temporarily store collected and/or calculated information. Collected information and/or calculated values and/or inputted information may for example be deleted from the sticker's storage means as soon as it has been transmitted from the sticker.

According to an embodiment of the invention the sticker provides a vibration status indicator that is arranged to indicate when a vibration of the machine comprising at least one rotating component exceeds a predetermined level and/or a temperature indicator comprising an indicator element that is arranged to indicate when a temperature of the machine comprising at least one rotating component exceeds a predetermined temperature. Such a vibration status indicator and/or temperature indicator may be used to provide information to users in the vicinity of the sticker and/or it/they may be arranged to trigger the transmitter to transmit the collected information when a vibration or temperature of the at least one part of the machine comprising at least one rotating component being monitored exceeds a predetermined vibration level or temperature respectively.

According to an embodiment of the invention the sticker provides at least one alarm arranged to indicate an alarm condition. For example, an optic and or acoustic alarm signal may be issued by the sticker and/or by a device receiving information transmitted from the sticker if/when excessive vibration and/or excessive temperature is detected. The at least one alarm may be adjustable, by an end-user for example. Additionally or alternatively, the at least one alarm may provide a hysteresis or digital filter. During the commissioning of a system a sticker containing one or more specific pre-defined alarm limits may be selected by a user or provided through different machine models, or a manufacturer. The sticker is used to link at least one component to at least one machine. The sticker is then used to track the performance of that at least one machine and the specific rotating component via information contained in the sticker's machine-readable label. In order to avoid a false alarm, alarm hysteresis filtering may be increased as the machine's overall vibration increases.

According to an embodiment of the invention the sticker provides energy-harvesting means to utilize energy generated by the machine comprising at least one rotating component.

According to an embodiment of the invention the machine provides at least part of one of the following: a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing, a ball screw, a gear, or a component for an application in which it is subjected to alternating Hertzian stresses.

The present invention also concerns a condition monitoring system for monitoring a condition of at least one machine comprising at least one rotating component, which provides at least one sticker according to any of the embodiments of the invention and a receiver arranged to receive information transmitted from the at least one sticker.

According to an embodiment of the invention the condition monitoring system provides a user interface that is arranged to allow a user to input information concerning the at least one machine comprising at least one rotating component, which inputted information is associated with the at least one sticker. For example, a user may select a particular machine model corresponding to the machine comprising at least one rotating component being monitored.

According to an embodiment of the invention the condition monitoring system provides central storage means arranged to store information collected from the at least one sticker. Information may for example be stored each time information is obtained from the sticker, whereupon the stored information may then be deleted from the sticker's storage means.

According to an embodiment of the invention the condition monitoring system provides and is arranged to provide a list of machine models and/or information about the machine models.

The present invention further concerns a method for monitoring a condition of at least one machine comprising at least one rotating component. The method provides the steps of attaching at least one sticker according to any of the embodiments of the invention to at least one part of at least one machine comprising at least one rotating component, associating the at least one sticker with the at least one part of the at least one machine comprising at least one rotating component, and collecting information from the at least one sticker in order to monitor the condition of the at least one part of the least one machine comprising at least one rotating component.

The present invention also concerns a computer program product that provides a computer program containing computer program code means arranged to cause a computer or a processor to execute the steps of associating at least one sticker with at least one machine comprising at least one rotating component and collecting information from the at least one sticker in a method according to any of the embodiments of the invention, which computer program is stored on a computer-readable medium or a carrier wave.

The sticker, condition monitoring system, method, and/or computer program product according to the present invention may be used to monitor any machine comprising at least one rotating component used in automotive, aerospace, railroad, mining, wind, marine, metal producing or any other application in which excessive vibration or temperature of at least part of the machine comprising at least one rotating component is not desired.

It should be noted that any feature of one embodiment of the invention may be combined with any other feature of any other embodiment of the invention unless the description explicitly excludes such a combination.

### BRIEF DESCRIPTION OF THE SEVERAL VIEWS OF THE DRAWING

The present invention will hereinafter be further explained by means of non-limiting examples with reference to the appended schematic figures where;

FIG. 1 shows a sticker according to an embodiment of the invention in both the normal and abnormal operation of a component being monitored,

FIG. 2 shows a condition monitoring system according to an embodiment of the invention, and

FIG. 3 is a flow chart showing the steps of a method according to an embodiment of the invention.

It should be noted that the drawings have not necessarily been drawn to scale and that the dimensions of certain features may have been exaggerated for the sake of clarity.

### DETAILED DESCRIPTION OF THE INVENTION

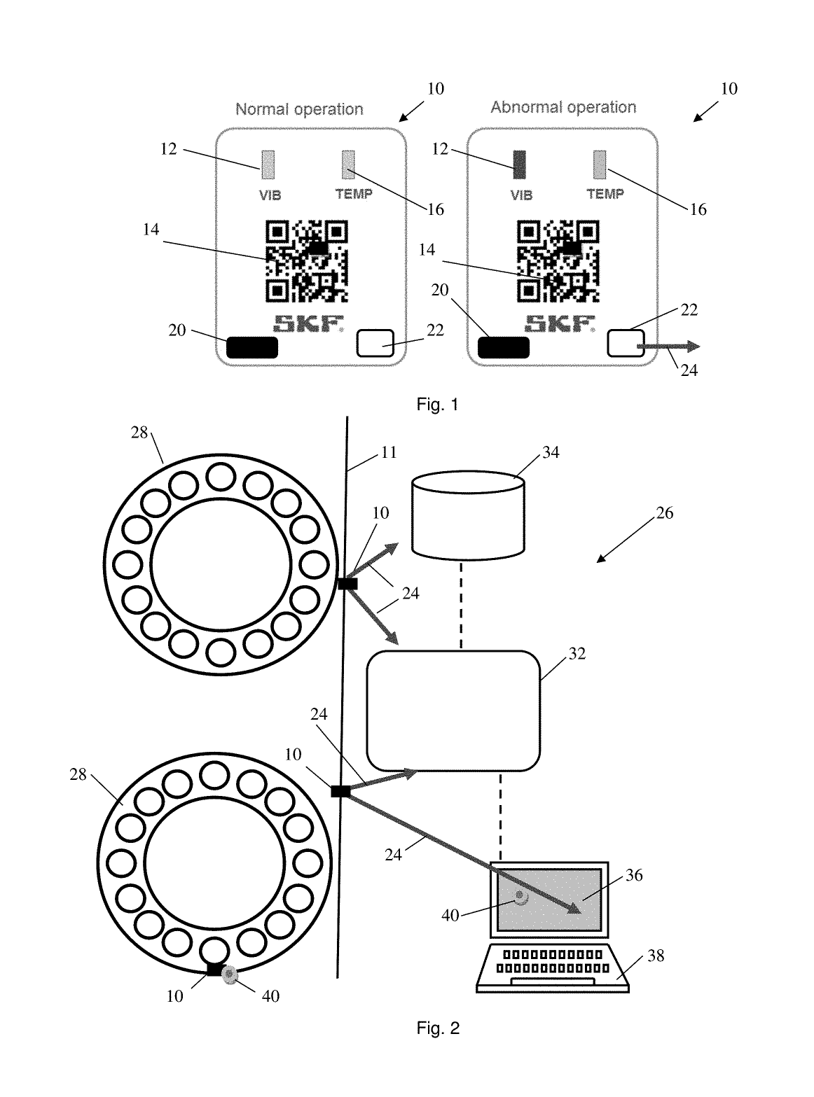

FIG. 1a) shows a sticker 10 for attaching to at least one part of a machine comprising at least one rotating component that is to be monitored during normal operation of the machine.

The sticker 10 illustrated in FIG. 1 provides two LEDs labelled “VIB” 12 and “TEMP” 16, which are arranged to light up or change colour when the vibration or the temperature of the machine comprising at least one rotating component that is being monitored exceeds a predetermined level/value, which predetermined level/value may be changed depending on the machine model, application and/or operating conditions in which the machine is used, whereby the light is detectable to the human eye and/or to a sensor that collects information from the sticker 10. It should be noted that a sticker according to the present invention may provide any type of vibration or temperature indicator and/or any type of vibration or temperature sensor.

The sticker 10 may provide a paper label having an adhesive at its rear surface, whereby the sticker 10 may be removably attached to the surface of a part of a machine comprising at least one rotating component by pressing the adhesive backing of the sticker 10 against the surface. Alternatively, the sticker may be stuck to a surface in the vicinity of the machine comprising at least one rotating component that is to be monitored.

The sticker 10 illustrated in FIG. 1 also provides a machine-readable label 14, such as a Quick Response (QR) code or bar code, which contains information about the at least one rotating component that is installed in the machine, such as a unique serial number for the at least one rotating component and/or type of the machine or the at least one rotating component and/or information about how the machine or the at least one rotating component should be used. A user may scan or photograph this machine-readable label 14 and associate at least one rotating component being monitored with a particular machine in a plant and/or location of a machine, and/or a geographical location and/or an end-user and/or installation date and/or days/hours of use, so that information collected from the sticker 10 and any other relevant information inputted by a user or manufacturer can be associated with a particular rotating component in a particular machine.

The sticker 10 also provides a processor 20 a processor arranged to collect information concerning the use of at least one component 28 and/or machine 11 comprising at least one rotating component and a transmitter 22 that is arranged to automatically transmit the collected information if/when the processor 20 collects information that a temperature of the at least one part of the machine comprising at least one rotating component being monitored exceeds a predetermined temperature value or the vibration of the at least one part of the machine comprising at least one rotating component exceeds a predetermined level.

During normal operating conditions neither the vibration level nor the temperature of the machine comprising at least one rotating component exceeds a predetermined level/value, but lies within a normal range for a particular component in a particular application. The predetermined level may be determined/selected by a manufacturer or user depending on the machine comprising at least one rotating component and the application in which the machine comprising at least one rotating component is used. Information concerning suitable alarm levels may be transmitted or uploaded to a sticker at the time of commissioning. A machine or component manufacturer may provide a suitable sticker 10 on a machine comprising at least one rotating component supplied to an end-user or within the component packaging. Alternatively or additionally, a sticker's alarm level(s) may be changed or selected by a used depending on the machine in which a rotating component is being used and/or its operating conditions.

FIG. 1b) shows the same sticker 10 as in FIG. 1a) during abnormal operation of the machine comprising at least one rotating component where the vibration level of the machine comprising at least one rotating component exceeds a predetermined level and lies above what is considered to be a normal vibration range for that machine comprising at least one rotating component in that application. The vibration status indicator LED 12 lights up or changes colour and the transmitter 22 transmits a signal 24 indicating that the vibration of the at least one part of a machine comprising at least one rotating component that is being monitored has exceeded a predetermined level. The signal 24 may be seen or collected by a user and/or sent to a user/operator and/or a machine and/or component manufacturer and/or to a central processor or database and/or to central storage means.

The sticker 10 according to the present invention may be of any size, thickness, colour and shape and may optionally contain more information, devices or sensors than those illustrated or described herein. For example, a sticker 10 may provide energy-harvesting means to utilize energy generated by a machine comprising at least one rotating component machine comprising at least one rotating component being monitored, a battery or energy-generating means, such as a solar panel.

FIG. 2 shows a condition monitoring system 26 according to an embodiment of the invention. The condition monitoring system 26 may be used for monitoring the condition of at least one machine 11 comprising at least one rotating component 28 or a plurality of machines 11 comprising at least one rotating component 28, and provides one sticker 10 or a plurality of stickers 10 according to any of the embodiments of the invention and a receiver 32 arranged to receive information transmitted from the at least one sticker 10. One or more stickers 10 may be attached to each machine 11 comprising at least one rotating component 28, preferably as close as possible to the at least one component 28. A sticker 10 according to the present invention is used to monitor the operation of at least one rotating component 28 in at least one machine 11, but may also be used to detect faults such as imbalance and misalignment of one or more machines 11, i.e. not only faults caused by at least one rotating component 28.

The illustrated embodiment shows a condition monitoring system 26 for monitoring the condition of a machine 11 comprising two rolling element bearings 28 during their use. The inner ring and/or outer ring of each bearing 28 may be of any size and have any load-carrying capacity. An inner ring and/or an outer ring may for example have a diameter up to a few metres and a load-carrying capacity up to many thousands of tonnes. The conditioning monitoring system 26 according to the present invention may however be used to monitor the condition of one or more machines 11 comprising at least one rotating component of any type, and not necessarily all of the same type or size.

The receiver 32 may be hand-held and/or portable or non-portable devices that can be carried or moved by a user or they may be fixed in a particular location to collect information from one or more stickers 10. A receiver may be a mobile telephone, media player, Personal Communications System (PCS) terminal, Personal Data Assistant (PDA), laptop computer, palmtop receiver, or camera. A receiver 32 may for example provide an application that provides a computer program containing computer program code means arranged to cause a computer or a processor to execute the steps of associating at least one sticker 10 with at least one machine 11 comprising at least one rotating component 28 and collecting information from the at least one sticker 10 in a method according to any of the embodiments of the invention.

The condition monitoring system 26 may provide a processor arranged to process information collected from at least one sticker 10. The condition monitoring system 26 may also provide and be arranged to provide a list of machine models and information concerning each machine model, such as the position of at least one rotating component in a machine, alarm limits, behaviour characteristics. These pre-defined machine models may be used by an operator during the commissioning. Data may be transmitted from a sticker's transmitter 22 to a receiver and/or to a central, local or remote processor in a wired or wireless manner, over a wireless communication network for example.

The condition monitoring system 26 may also provide storage means 34, such as a database, arranged to store information transmitted from at least one sticker 10, whereby the information is preferably stored in a way that it can be readily associated with a particular machine 11 comprising at least one rotating component 28 being monitored. The storage means 34 may be maintained by a manufacturer of the machine(s) 11 and/or component(s) 28 being monitored. The data collected from a plurality of machines 11 comprising at least one rotating component 28 of a particular type used in the same or similar application(s) may enable a manufacturer to track the performance of machine 11 comprising at least one rotating component and/or extract further information about relationships between the performance of machines 11 and/or rotating components of different types and conditions of usage so as to further improve the service to end-users.

The condition monitoring system 26 may provide display means 36, such as a display screen in any central, remote or local location, or in one or more receivers that is/are arranged to collect information from one or more stickers 10 so that a user and/or machine 11 and/or component manufacturer can information being transmitted from the sticker(s) 10.

It should be noted that not all of the components of the condition monitoring system 26 necessarily need to be located in the vicinity of the machine 11 comprising at least one rotating component 28 being monitored. For example, the storage means 34 may located at a remote location and communicate with at least one receiver 32 by means of a server for example. Alternatively, the receiver 32, display means 36, user interface 38 and/or, storage means 34 may all be located in the same unit such as a personal computer.

The condition monitoring system 26 may even provide a user interface 38 that is arranged to allow a user and/or machine 11 or component manufacturer to input information concerning at least one machine 11 comprising at least one rotating component 28 being monitored, which inputted information may be associated with at least one sticker 10 and optionally stored with information collected from the at least one sticker 10 and/or sent to a manufacturer of the at least one machine 11 comprising at least one rotating component 28 being monitored. Such a user interface 38 may be incorporated into one or more receivers 32 that is/are arranged to receive information from one or more stickers 10.

A sticker 10 according to the present invention may provide at least one alarm 40 arranged to indicate an alarm condition such as excessive vibration or an excessively high temperature. The alarm 40 may for example issue an optical and/or acoustic signal when the vibration or the temperature of a part of a machine 11 comprising at least one rotating component 28 being monitored exceeds a predetermined level. Such an alarm 40 may be arranged to be seen and/or heard via display means 36 or via a receiver 32 that is arranged to receive information from one or more stickers 10 instead of, or in addition to on a sticker 10 itself. This alarm 40 could be used as a trigger to ensure that a machine 11 comprising at least one rotating component 28 being monitored is checked immediately.

Notification of when it is advisable to service, replace or refurbish one or more machine 11 comprising at least one rotating component 28 being monitored by the condition monitoring system 26 may be made in any suitable manner, such as via a communication network, via an e-mail or telephone call, a letter, facsimile, alarm signal, or a visiting representative of the manufacturer or user. Once a component 28 has been replaced, a new sticker may be attached to the machine comprising the replacement component 28 and the machine-readable label 14 of the new sticker 10 is associated with the machine comprising the replaced rotating component 28 that is to be monitored. Preferably, when a rotating component 28 is replaced, a new machine-readable label 14 is placed over the previous machine-readable label 14 of the existing sticker 10 so that the existing sticker 10 can be re-used. The performance of a rotating component 28 in a specific machine 11 may be tracked in this way. The machine's Mean Time Between Failures (MTBF) can also be calculated from this.

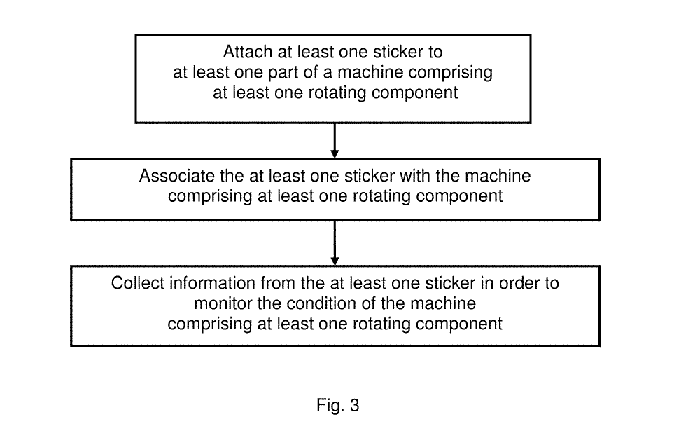

FIG. 3 is a flow chart showing the steps of a method according to an embodiment of the invention. The method provides the steps of attaching at least one sticker according to any of the embodiments of the invention to at least one part of at least one machine comprising at least one rotating component (which step may be carried out by a manufacturer or user of the machine or component), associating the at least one sticker with additional information concerning the at least one machine comprising at least one rotating component being monitored, such as its location, and collecting information from the at least one sticker in order to monitor the condition of the at least one part of the at least one machine comprising at least one rotating component. The collected information may then be analyzed, transmitted and/or displayed to a user and/or machine or component manufacturer, and/or stored.

Further modifications of the invention within the scope of the claims would be apparent to a skilled person.

1. A sticker for attaching to at least one part of a machine comprising:
at least one rotating component to be monitored, wherein
the sticker provides a machine-readable label, such as a Quick Response (QR) code or bar code that contains information about the at least one rotating component, such as a serial number of the at least one rotating component, and a processor arranged to collect information concerning the use of the at least one component and/or the machine and a transmitter arranged to automatically transmit the collected information if/when the processor collects information that a temperature of the at least one part of the machine being monitored exceeds a predetermined temperature or a vibration of the at least one part of the component machine exceeds a predetermined level, wherein
the transmitted collected information is arranged to be associated with the machine-readable label.

2. The sticker according to claim 1, wherein the processor is arranged to calculate at least one of the following: average temperature, average vibration level, running time.

3. The sticker according to claim 2, wherein the sticker is arranged to start calculating and/or transmitting such calculated values only on request.

4. The sticker according to claim 1, further comprises storage means arranged to at least temporarily store collected and/or calculated information.

5. The sticker according to claim 1, further comprises a vibration status indicator arranged to indicate when a vibration of the machine exceeds a predetermined level and/or a temperature indicator comprising an indicator element that is arranged to indicate when a temperature of the machine exceeds a predetermined temperature.

6. The sticker according to claim 1, further comprises at least one alarm arranged to indicate an alarm condition.

7. The sticker according to claim 6, wherein the at least one alarm is adjustable, and/or comprises a hysteresis or digital filter.

8. The sticker according to claim 1, further comprises energy-harvesting means to utilize energy generated by the machine.

9. The sticker according to claim 1, wherein the machine comprises at least part of one of the following: a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing, a ball screw, a gear, or a component for an application in which it is subjected to alternating Hertzian stresses.

10. A condition monitoring system for monitoring the condition of at least one machine comprising:
at least one rotating component,
at least one sticker, the sticker provides a machine-readable label, such as a Quick Response (QR) code or bar code that contains information about the at least one rotating component, such as a serial number of the at least one rotating component, and a processor arranged to collect information concerning the use of the at least one component and/or the machine and a transmitter arranged to automatically transmit the collected information if/when the processor collects information that a temperature of the at least one part of the machine being monitored exceeds a predetermined temperature or a vibration of the at least one part of the component machine exceeds a predetermined level, wherein
the transmitted collected information is arranged to be associated with the machine-readable label, and
a receiver arranged to receive information transmitted from the at least one sticker.

11. The condition monitoring system according to claim 10, further comprises a user interface arranged to allow a user to input information concerning the at least one rotating component, which inputted information is associated with the at least one sticker.

12. The condition monitoring system according to claim 10, further comprises central storage means arranged to store information collected from the at least one sticker.

13. The condition monitoring system according to claim 10, further comprises being arranged to provide a list of machine models and/or information about machine models.

14. A method for monitoring a condition of at least one machine comprising:
providing at least one rotating component,
attaching at least one sticker to at least one part of at least one machine having at least one rotating component that provides a machine-readable label, such as a Quick Response (QR) code or bar code that contains information about the at least one rotating component, such as a serial number of the at least one rotating component, and a processor arranged to collect information concerning the use of the at least one component and/or the machine and a transmitter arranged to automatically transmit the collected information if/when the processor collects information that a temperature of the at least one part of the machine being monitored exceeds a predetermined temperature or a vibration of the at least one part of the component machine exceeds a predetermined level, the transmitted collected information is arranged to be associated with the machine-readable label,
associating the at least one sticker with the at least one part of the at least one machine, and
collecting information from the at least one sticker in order to monitor the condition of the at least one part of the least one machine having at least one rotating component.
